(19) United States
(12) Patent Application Publication
(10) Pub. No.: US 2012/0067676 A1
(43) Pub. Date: Mar. 22, 2012

(54) VEHICLE WHEEL BRAKING SYSTEM

(75) Inventors: Craig A. Bramscher, Ashland, OR (US); Roger Gerson, Medfield, MA (US); Raphael Schlanger, Wilton, CT (US); Daniel M. Riegels, Ashland, OR (US)

(73) Assignee: Brammo, Inc., Ashland, OR (US)

(21) Appl. No.: 12/884,787

(22) Filed: Sep. 17, 2010

(51) Int. Cl. B60T 1/00; B60T 1/06; F16D 55/22; B62L 1/00; B60T 8/176; B60T 1/10; B62L 3/00

(52) U.S. Cl. 188/71.1; 188/106 P; 303/152

(57) ABSTRACT

A braking system for a wheel of a vehicle includes a regenerative brake unit and a friction brake unit. The regenerative brake unit comprises a generator including a rotor and a stator. The rotor is fixedly attached to the wheel and includes a moving friction surface integrally constructed thereon. The friction brake unit includes a stationary friction surface that engages the moving friction surface of the rotor when the friction brake unit is actuated.

### BACKGROUND

The present application relates generally to braking systems for vehicles and, more particularly to a vehicle wheel braking system that includes a friction brake and a regenerative brake.

Electrically regenerative vehicle wheel braking systems include a motor/generator unit having a rotor and a stator. The stator is, by definition, stationary or fixed, while the rotor rotates relative to the stator. The rotor and stator both include field coils and/or permanent magnets to create a magnetic field. A “permanent magnet” motor/generator utilizes permanent magnets in one of the rotor or the stator and field coils in the other. An “induction” motor/generator utilizes field coils in both the rotor and stator. When the motor/generator unit is in the mode to function as a motor, electricity is provided to the unit, which then serves to provide motive torque to propel the vehicle. When the motor/generator is in the mode to function as a generator, the reverse occurs and motive torque is absorbed by the unit to provide a current output, which can be utilized for work or stored in batteries or other electrical storage devices. This process is known as regenerative braking.

Friction-type brakes include a stationary friction surface and a moving friction surface. When these two surfaces are pressed into contact, the moving surface is slowed relative to the stationary surface, thereby reducing the kinetic energy of the moving surface, and dissipating the kinetic energy in the form of heat. Examples of common friction braking systems include disc brakes, drum brakes, and band brakes.

### BRIEF SUMMARY OF EMBODIMENTS OF THE INVENTION

A braking system for a wheel of a vehicle in accordance with one or more embodiments includes a regenerative brake unit and a friction brake unit. The regenerative brake unit comprises a generator including a rotor and a stator. The rotor is fixedly attached to the wheel and includes a moving friction surface integrally constructed thereon. The friction brake unit includes a stationary friction surface that engages the moving friction surface of the rotor when the friction brake unit is actuated.

A braking system for a wheel of a vehicle in accordance with one or more alternate embodiments includes a regenerative brake unit comprising a switched reluctance generator including a rotor and a stator. The rotor is fixedly attached to the wheel and includes a moving friction surface thereon. The braking system also includes a friction brake unit having a stationary friction surface that engages the moving friction surface of the rotor when the friction brake unit is actuated.

Various embodiments of the invention are provided in the following detailed description. As will be realized, the invention is capable of other and different embodiments, and its several details may be capable of modifications in various respects, all without departing from the invention. Accordingly, the drawings and description are to be regarded as illustrative in nature and not in a restrictive or limiting sense, with the scope of the application being indicated in the claims.

### BRIEF DESCRIPTION OF THE DRAWINGS

FIG. 1 is a schematic block diagram of an exemplary vehicle in which a braking system in accordance with one or more embodiments can be implemented.

FIGS. 2A and 2B (collectively FIG. 2) are exploded and collapsed views, respectively, of portions of a braking system in accordance with one or more embodiments.

FIGS. 3A and 3B (collectively FIG. 3) are exploded and collapsed views, respectively, of portions of a braking system in accordance with one or more embodiments.

FIGS. 4A and 4B (collectively FIG. 4) are exploded and collapsed views, respectively, of portions of a braking system in accordance with one or more embodiments.

FIGS. 5A and 5B (collectively FIG. 5) are exploded and collapsed views, respectively, of portions of a braking system in accordance with one or more embodiments.

FIGS. 6A and 6B (collectively FIG. 6) are side and quarter-side views, respectively, of portions of another braking system in accordance with one or more embodiments.

FIG. 7 is a schematic illustration of an exemplary switched reluctance motor/generator that can be used in a braking system in accordance with one or more embodiments.

Like reference characters denote like parts in the drawings.

### DETAILED DESCRIPTION

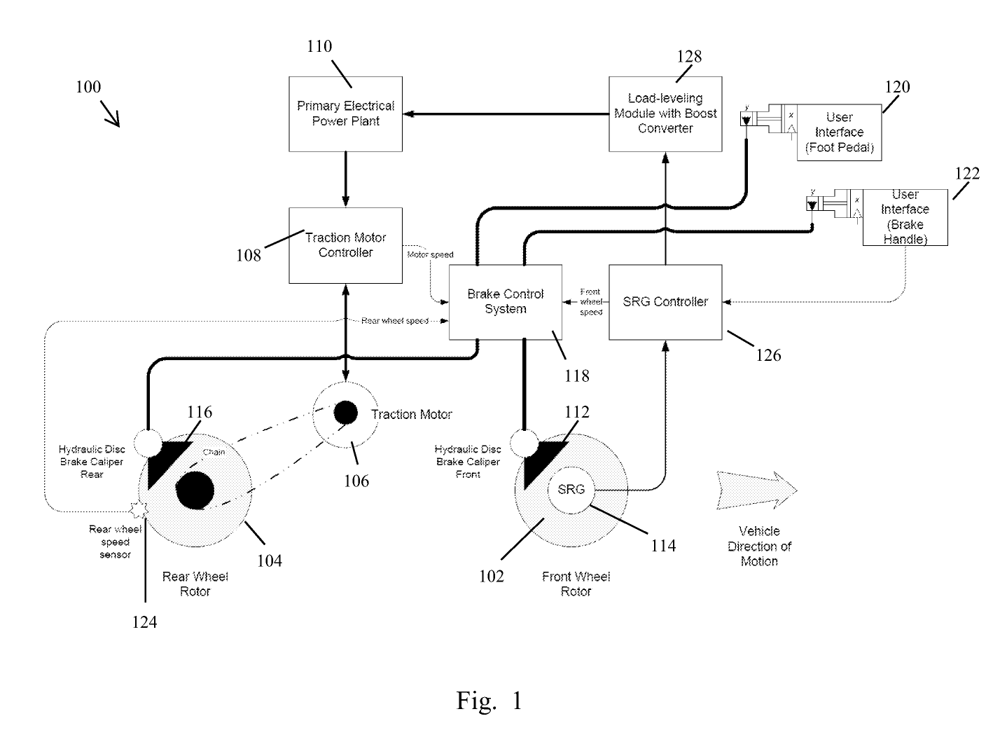

FIG. 1 schematically illustrates an example of a vehicle 100, which includes a braking system in accordance with one or more embodiments of the invention. In the illustrated example, the vehicle is a two-wheeled electric motorcycle. However, it should be understood that braking systems described herein can also be used in many other types of vehicles including hybrid and conventional engine-driven vehicles, as well as in vehicles having three or more wheels.

The vehicle includes a front wheel 102 and a rear wheel 104, which is driven by a traction motor 106 through a chain drive mechanism, belt drive, shaft drive or any similar means of transferring motion from the motor to the rear wheel. The traction motor 106 is controlled by a traction motor controller 108, which controls power to the traction motor 106 from a primary electrical power plant 110, e.g., a battery.

The braking system of the vehicle includes a friction brake unit 112 and a regenerative brake unit 114 at the front wheel 102 as will be described in greater detail below. The vehicle 100 includes an additional friction brake unit 116 at the rear wheel 104 of the vehicle. The friction brake units in the illustrated example comprise hydraulic disc brake calipers. Alternatively, the friction brake units can comprise continuous circular friction surfaces. The friction brake units can also comprise electro-mechanical disc brakes.

A brake control system 118 is provided to control operation of the friction brake units. The brake control system 118 can optionally comprise an antilock brake system.

The braking system includes one or more user interfaces, e.g., a foot pedal 120 and/or a brake handle 122, which can be operated by a user to actuate the brakes. The foot pedal 120 controls the rear-wheel brake, and the brake handle 122 controls the front wheel brake. A rear wheel speed sensor 124 provides data on the rear wheel speed to the brake control system 118.

In the exemplary vehicle 100, the regenerative brake unit 114 is installed in the hub of the front wheel 102. In the illustrated embodiment, the regenerative brake unit 114 includes a switched reluctance generator (SRG). In other embodiments, the regenerative brake unit 114 can include other types of generators including, e.g., permanent magnet generators and induction generators. The switched reluctance generator is controlled by an SRG controller 126, which receives current generated from the SRG unit as well as information on front wheel speed. The SRG controller 126 transmits data on front wheel speed to the brake control system 118. The SRG controller 126 transmits current generated by the SRG unit 114 to a load-leveling module 128 with boost converter. The load leveling module 128 transmits the current to the primary electrical power plant 110. The load-leveling module 128 converts fast transient currents into direct currents (DC) at an appropriate voltage level to charge batteries.

The regenerative brake unit 114 can be used as a “drag brake” to slow the vehicle down. As the vehicle slows, the regenerative brake unit 114 generates current to recharge an onboard battery or other electrical storage device such as a capacitor. In the event the regenerative brake unit 114 cannot apply enough braking torque to the wheel (e.g., in a panic or sudden braking situation), the friction brake unit is actuated to provide heavy braking. If the regenerative brake unit 114 fails or becomes unavailable, the friction brake unit operates like a traditional friction brake. This makes the braking system robust and fault tolerant.

One or more embodiments of the invention are directed to a braking system in which the rotor of the electrically generative braking unit is integrally constructed with a moving friction braking surface of the friction braking unit. The term “integral” or “integrally constructed” is used herein to mean formed in a single structure or connected together to make up a single unit that cannot be easily dismantled.

Braking systems having a rotor integrally constructed with the friction braking surface can have reduced manufacturing costs because the step of joining friction braking surfaces to rotors using mechanical fasteners is eliminated. Costs can also be reduced by avoiding the use of multiple separately formed rotor and friction surface components. Furthermore, the integral construction of the rotor and the friction braking surface can improve reliability and safety by eliminating use of mechanical fasteners, which can loosen during operation and compromise brake effectiveness. Furthermore, by avoiding use of mechanical fasteners, the braking system can have reduced weight.

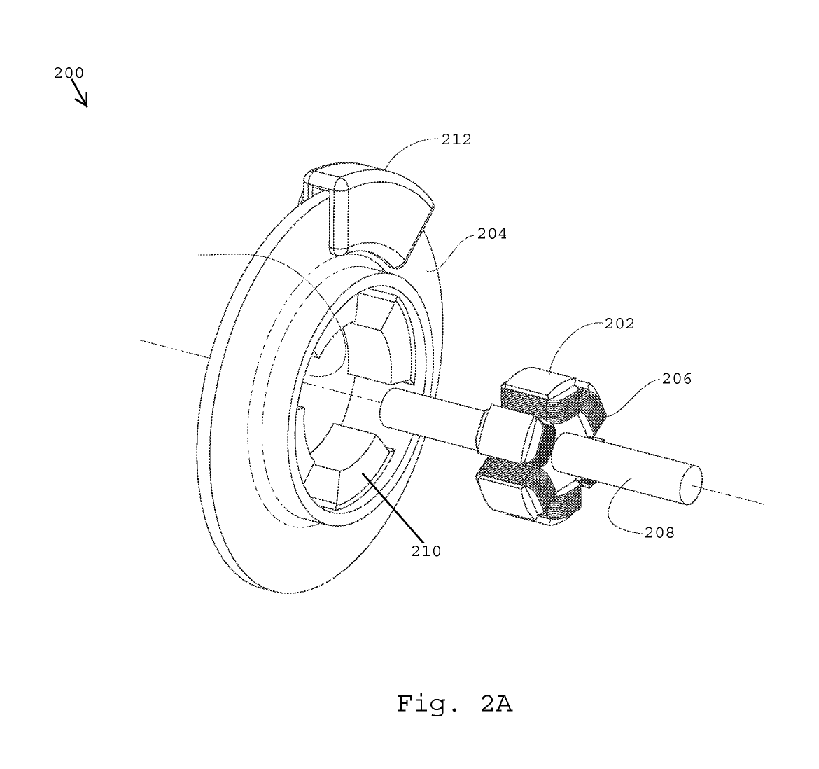

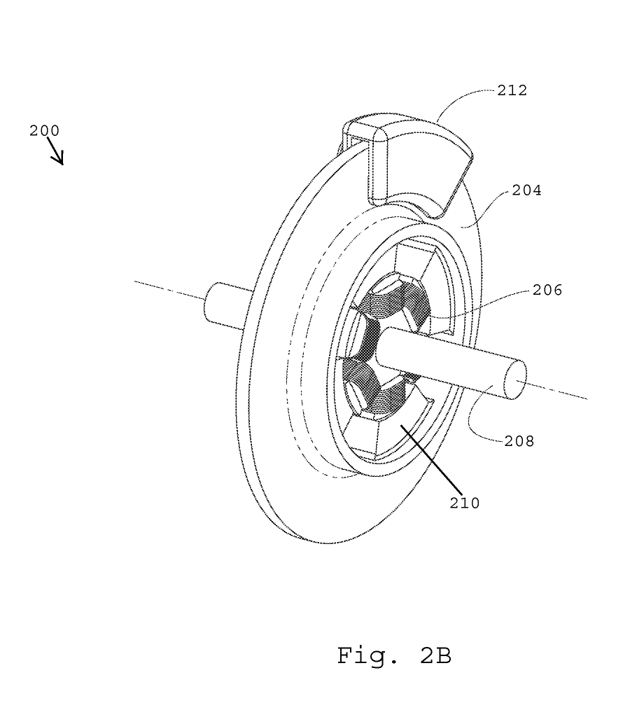

FIGS. 2-6 illustrate braking systems in accordance with various embodiments. The braking systems can be positioned within the hub of a wheel of a vehicle, e.g., the front wheel 102 of the vehicle shown in FIG. 1.

FIGS. 2A and 2B are exploded and collapsed views, respectively, of portions of an exemplary braking system 200 that includes a regenerative brake unit comprising a stator assembly 202 positioned concentrically within a rotor 204. The stator assembly 202 includes a set of field windings 206 arranged around the wheel axle 208. In an electric motorcycle, the axle 208 is mounted on the front fork of the motorcycle. The wheel spokes (not shown) are connected to the rotor 204.

The rotor 204 includes an arrangement of spaced-apart rotor poles 210 positioned around the stator assembly 202. The rotor poles 210 interact with the field windings 206 on the stator 202 as the rotor 204 rotates relative to the stator 202 to provide a current output.

The rotor 204 includes a friction disc integrally constructed with the magnetic structure of the rotor 204 including the rotor poles 210. In one or more embodiments, the friction disc is integrally formed in a single unit with the rest of the rotor 204 using processes such as machining, stamping, and casting. In other embodiments, the friction disc is integrally joined to the rest of the rotor 204 through processes such as welding, fusing, and bonding.

The braking system also includes a friction brake unit. The friction brake unit includes a brake caliper 212 that can be actuated to engage the friction disc of the rotor 204 to apply a braking force to the vehicle.

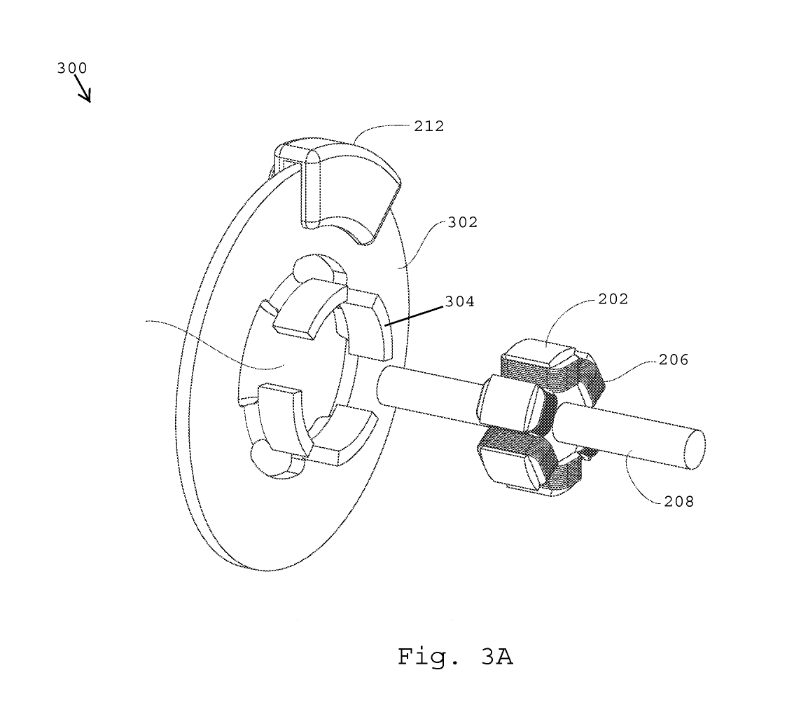

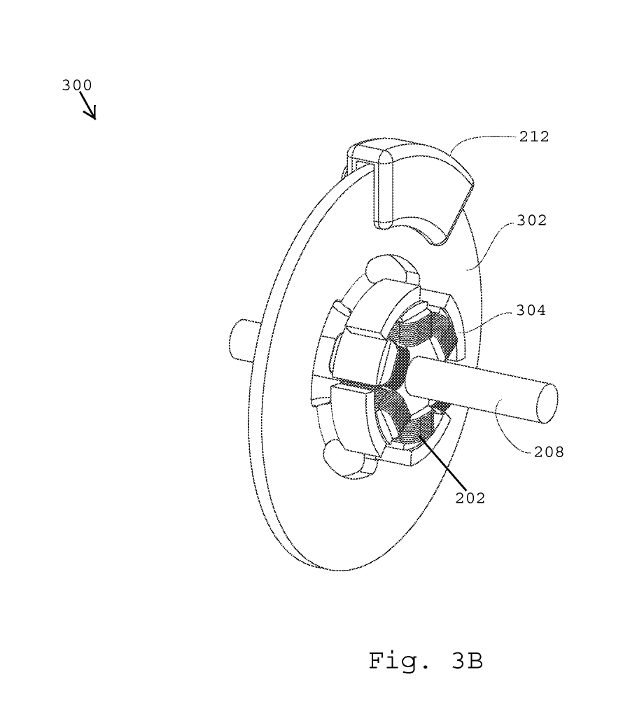

FIGS. 3A and 3B are exploded and collapsed views, respectively, of portions of an alternate braking system 300 in accordance with one or more embodiments. The braking system 300 includes a rotor 302 with an integrally constructed friction disc. Unlike the braking system of FIGS. 2A and 2B, the poles 304 of the rotor 302 are axially offset from the friction disc.

As used herein, an “axial” direction refers to a direction along the rotational axis of the rotor, while a “radial” direction is a direction generally perpendicular to the rotational axis of the rotor, extending radially outwardly from the rotational axis.

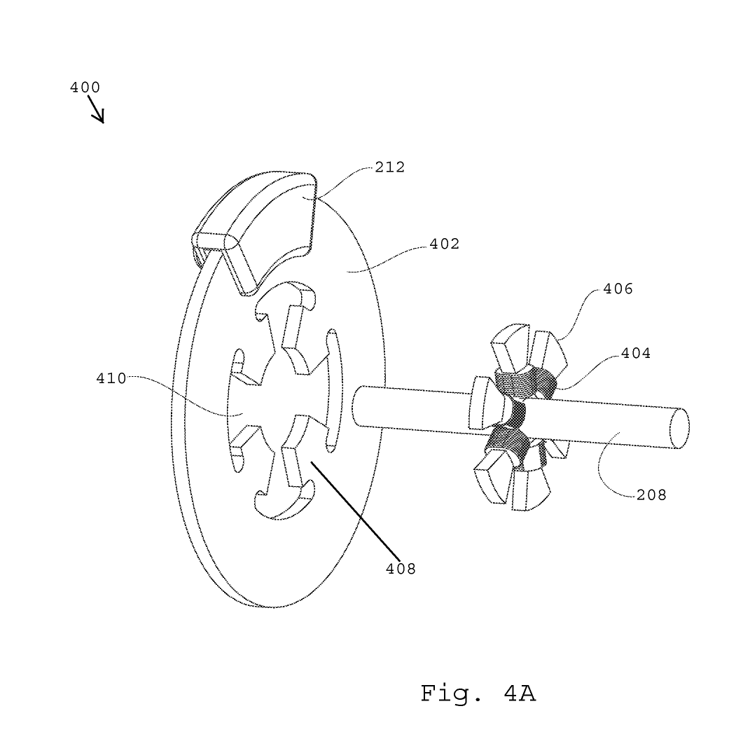

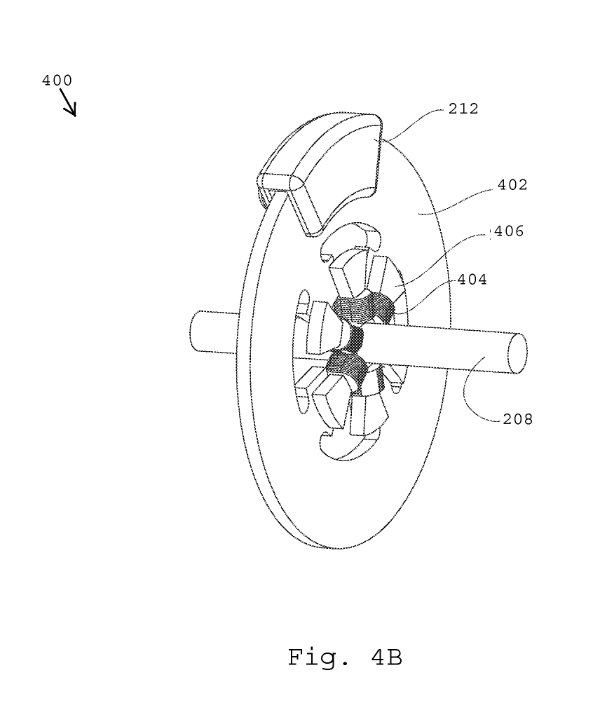

FIGS. 4A and 4B are exploded and collapsed views, respectively, of portions of a further alternate braking system 400 in accordance with one or more embodiments. The braking system 400 includes a rotor 402 with an integrally constructed friction disc. In this embodiment, the stator assembly includes field windings 404 on poles 406 extending radially from the axle 208. The rotor 402 comprises a generally flat disc having a set of poles 408 positioned in a spaced arrangement about a central opening 410 in the disc. As shown in FIG. 4B, during use, there is an axial air gap between the field windings 404 of the stator and the poles 408 on the rotor 402.

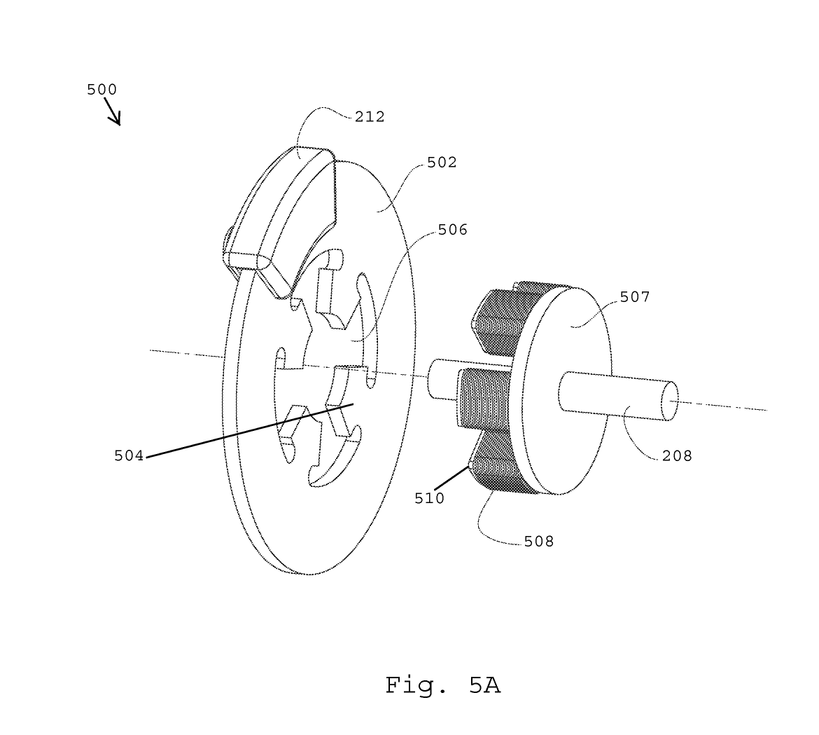

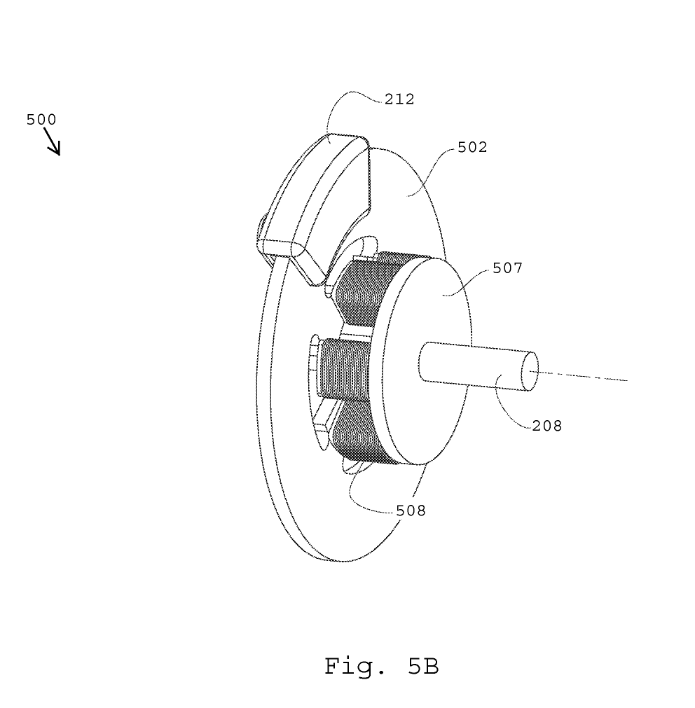

FIGS. 5A and 5B are exploded and collapsed views, respectively, of portions of another braking system 500 in accordance with one or more embodiments. The rotor of the braking system 500 is similar to the rotor in the FIGS. 4A and 4B embodiment. In particular, the rotor 502 comprises a generally flat disc having a set of rotor poles 504 positioned in a spaced arrangement about a central opening 506 in the disc. In the embodiment of FIGS. 5A and 5B, the stator assembly 507 includes field windings 508 on poles 510 that extend axially from the axle 208. As shown in FIG. 5B, during use, there is an axial air gap between the field windings of the stator and the poles on the rotor.

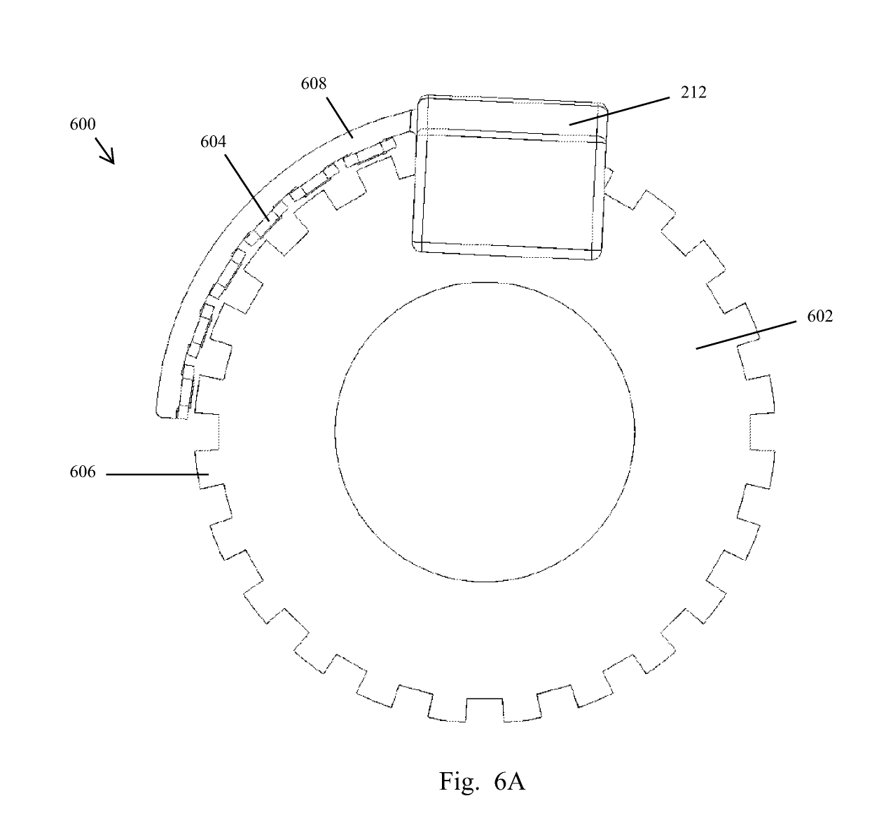

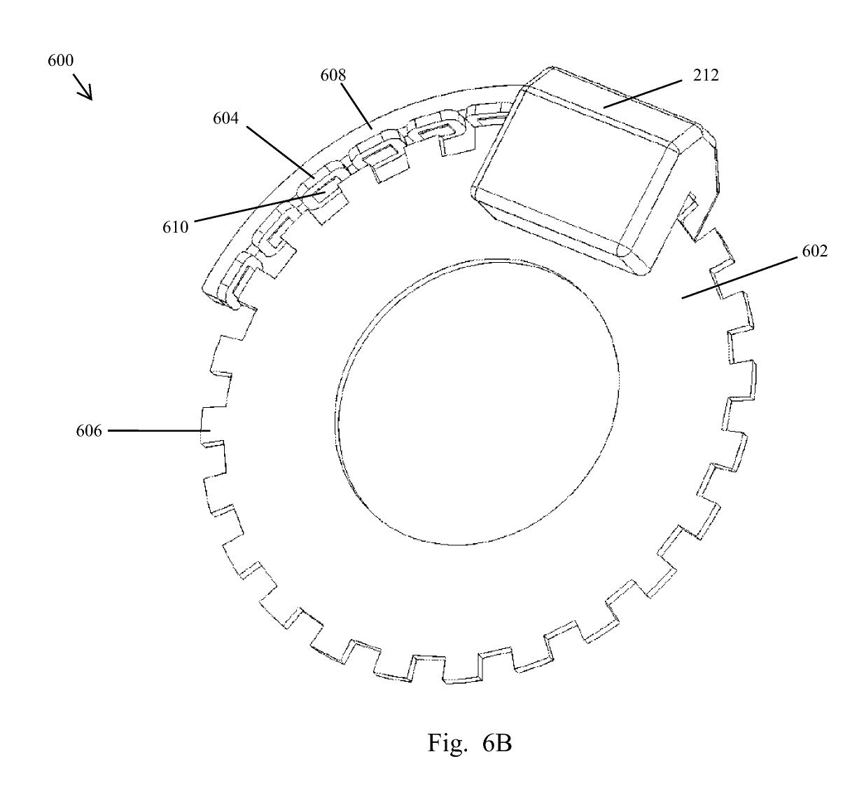

FIGS. 6A and 6B are side and quarter-side views, respectively, of portions of another braking system 600 in accordance with one or more embodiments. The rotor of the braking system 600 is similar to the rotor in the FIGS. 5A and 5B embodiment. In particular, the rotor 602 comprises a generally flat disk having a set of rotor poles 606 positioned in a spaced arrangement on the outer edge of the disc. In the embodiment of FIGS. 6A and 6B, the stator assembly 608 includes windings 604 on poles 610 that extend radially towards the center of the disc. As shown in FIG. 6A, during use, there is an radial air gap between the field windings of the stator and the poles on the rotor.

In the embodiments illustrated in FIGS. 2-6, the regenerative brake unit preferably comprises a switched reluctance generator. However, use of other types of generators including permanent magnet generators and induction generators is also contemplated.

A braking system in accordance with one or more alternate embodiments includes a regenerative brake unit, which has a switched reluctance generator, and an optional friction brake unit.

Switched reluctance generators utilize field windings in only one of the stator or the rotor. Accordingly, switched reluctance generators can avoid the additional weight and/or expense associated with the additional permanent magnets and/or field coils of many other generators.

Switched reluctance generators are generally less efficient than many other generators. However, in a regenerative braking application, the lower efficiency can be advantageous. The capacity of many batteries currently available to absorb recharging power without the inclusion of an electronic power converter is limited, especially in the interest of preserving battery life. Thus, a highly efficient regenerative brake would require additional components to regulate the recharge power to avoid any potential damage to the battery, thus adding cost and complexity to the vehicle. The lower efficiency of switched reluctance generators reduces recharge power and can be used without an electronic power converter to charge without damage or degradation of the batteries. Also, the output of the switch reluctance generator can be adjusted to the proper level by varying the excitation current that stimulates the generation process. Thus, use of switched reluctance generators can reduce cost and complexity to the system.

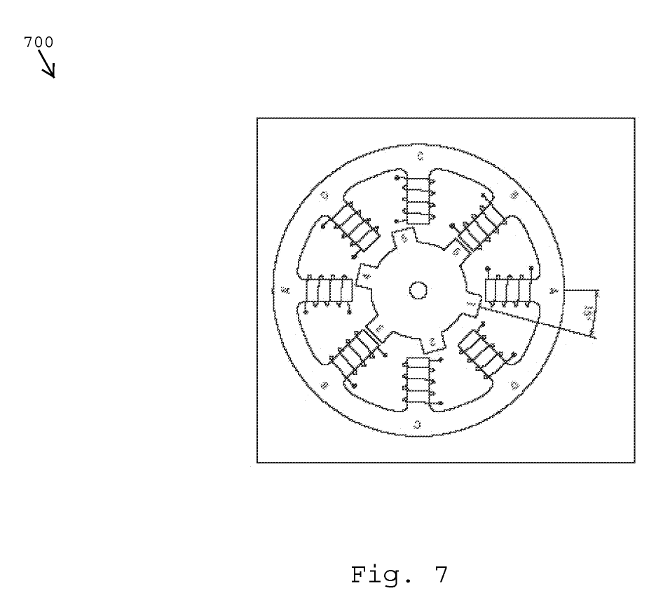

FIG. 7 is a schematic illustration of an exemplary switched reluctance motor/generator 700 that can be used in a braking system in accordance with one or more embodiments. The switched reluctance motor/generator includes an internal rotor having poles 1 thru 6. It also includes an external stator includes field wound poles A thru D and A′ thru D′. In the illustration, rotor poles 3 and 6 are aligned with excited stator poles B and B′. When the switched reluctance motor/generator operates as a motor, poles B and B′ are turned off and poles A an A′ are excited to create a magnetic flux, which serves to draw rotor poles 1 and 4 into alignment with stator poles A and A′. This applies a counterclockwise torque to the rotor and successive excitation of the stator poles will cause the rotor to continue to turn. Circuitry is used to sequentially excite the field wound poles A thru D and A′ thru D′.

When the switched reluctance motor/generator operates as a generator, an external torque is applied to rotate the rotor. As the rotor poles 1 thru 6 are rotated past the stator poles, current is generated in the corresponding stator field coils of the stator. This current may be harnessed to provide current to power accessories or to recharge a battery.

In the FIG. 7 illustration, the rotor is internal and circumferentially surrounded by the stator. In an alternative arrangement, the stator is internal and surrounded by a rotatable rotor.

In the illustrated device, the field coils are located on the poles of the stator. In an alternative arrangement, the field coils may be located on the poles of the rotor.

In addition, in FIG. 7, the stator is radially disposed from the rotor in a concentric configuration. In an alternative arrangement, the stator may be axially spaced from the rotor in a side by side configuration.

The switched reluctance generator unit can be implemented in a braking system in combination with a friction braking unit in similar fashion to the braking systems illustrated in FIGS. 2-7. The regenerative brake unit includes a rotor having moving friction surface that engages a stationary friction surface of the friction braking unit. In preferred embodiments, the moving friction surface is integrally constructed on the rotor. However, in alternate embodiments, the moving friction surface can be joined to the rotor using bolts or other mechanical fasteners or assembly techniques.

Braking systems in accordance with one or more embodiments described herein utilize an internal stator that serves as axle and a concentric external rotor. The axle mounts in the fork of the vehicle if it is a motorcycle. The concentric external rotor serves as a hub shell to which the spokes or rim of the wheel are connected. This arrangement utilizes a radial air gap. The internal stator includes field coils while the rotor includes poles. This arrangement is preferable since it is easier to provide electrical connections to a stationary stator. Electrical connections to a rotor use brushes and other mechanisms, which wear out over time and are vulnerable to damage, corrosion, and degradation.

In other embodiments, the rotor is internal and the stator is positioned externally and concentrically around the rotor. In an electric motorcycle, the fork dropouts can include bearings that allow the internal rotor to rotate about the axial axis. The external stator can cup around the rotor and be attached to the fork leg.

It is to be understood that although the invention has been described above in terms of particular embodiments, the foregoing embodiments are provided as illustrative only, and do not limit or define the scope of the invention. Various other embodiments, including but not limited to the following, are also within the scope of the claims. For example, elements and components described herein may be further divided into additional components or joined together to form fewer components for performing the same functions.

Having described preferred embodiments of the present invention, it should be apparent that modifications can be made without departing from the spirit and scope of the invention.

Method claims set forth below having steps that are numbered or designated by letters should not be considered to be necessarily limited to the particular order in which the steps are recited.

What is claimed is:

1. A braking system for a wheel of a vehicle, comprising:
a regenerative brake unit comprising a generator including a rotor and a stator, said rotor being fixedly attached to said wheel and including a moving friction surface integrally constructed thereon; and
a friction brake unit having a stationary friction surface that engages the moving friction surface of the rotor when the friction brake unit is actuated.

2. The braking system of claim 1 wherein the moving friction surface is integrally formed with the rotor.

3. The braking system of claim 1 wherein the moving friction surface is integrally joined to a surface of the rotor.

4. The braking system of claim 2 wherein the moving friction surface is welded, fused, or bonded on the surface of the rotor.

5. The braking system of claim 1 wherein the vehicle is a two wheeled vehicle.

6. The braking system of claim 1 wherein the vehicle is a three or more wheeled vehicle.

7. The braking system of claim 1 wherein in one mode of operation, the rotor and stator comprise a motor for driving the wheel.

8. The braking system of claim 1 wherein the generator comprises a switched reluctance generator.

9. The braking system of claim 1 wherein the generator comprises a permanent magnet generator or an induction generator.

10. The braking system of claim 1 wherein the rotor rotates around the stator.

11. The braking system of claim 1 wherein the rotor rotates within the stator.

12. The braking system of claim 1 wherein the moving friction surface is axially spaced from the body of the rotor.

13. The braking system of claim 1 wherein the moving friction surface is axially aligned with the body of the rotor.

14. The braking system of claim 12 wherein the moving friction surface is located radially outboard of the body of the rotor.

15. The braking system of claim 12 wherein the moving friction surface is located radially inboard of the body of the rotor.

16. The braking system of claim 1 wherein the moving friction surface comprises a circular friction surface that circumscribes a rotational axis of the wheel.

17. The braking system of claim 1 wherein the stator is radially spaced from the rotor with a radially extending air gap therebetween.

18. The braking system of claim 1 wherein the stator is axially spaced from the rotor with an axially extending air gap therebetween.

19. The braking system of claim 1 further comprising a user actuation device and a controller coupled to the user actuation device, the regenerative brake unit, and the friction brake unit, said controller controlling operation of the regenerative brake unit and the friction brake unit.

20. The braking system of claim 19 wherein the generator comprises a switched reluctance generator, and the friction brake unit includes an antilock brake mechanism, and wherein the switched reluctance generator provides wheel speed data to the controller for use in controlling operation of the antilock brake mechanism.

21. The braking system of claim 19 wherein the generator comprises a switched reluctance generator, and the friction brake unit comprises a hydraulic-mechanical disc brake, and further comprising an antilock brake system (ABS) controller for controlling the hydraulic-mechanical disc brake in an antilock braking mode, wherein the switched reluctance generator provides wheel speed data to the ABS controller for use in controlling operation of the hydraulic-mechanical disc brake in the antilock braking mode.

22. The braking system of claim 19 wherein the friction brake unit comprises an electro-mechanical disc brake and an electric motor for driving the disc brake, and wherein the generator comprises a switched reluctance generator that provides wheel speed data to the controller, and wherein the controller uses the wheel speed data for controlling operation of the electro-mechanical disc brake in an antilock braking mode.

23. A braking system for a wheel of a vehicle, comprising:
a regenerative brake unit comprising a switched reluctance generator including a rotor and a stator, said rotor being fixedly attached to said wheel and including a moving friction surface thereon; and
a friction brake unit having a stationary friction surface that engages the moving friction surface of the rotor when the friction brake unit is actuated.

24. The braking system of claim 23 wherein the moving friction surface is integrally constructed on the rotor.

25. The braking system of claim 24 wherein the moving friction surface is integrally formed with other parts of the rotor.

26. The braking system of claim 24 wherein the moving friction surface is integrally joined to a surface of the rotor.

27. The braking system of claim 26 wherein the moving friction surface is welded, fused, or bonded on the surface of the rotor.

28. The braking system of claim 23 wherein the vehicle is a two wheeled vehicle.

29. The braking system of claim 23 wherein the vehicle is a three or more wheeled vehicle.

30. The braking system of claim 23 wherein in one mode of operation, the rotor and stator comprise a motor for driving the wheel.

31. The braking system of claim 23 wherein the rotor rotates around the stator.

32. The braking system of claim 23 wherein the rotor rotates within the stator.

33. The braking system of claim 23 wherein the moving friction surface is axially spaced from the body of the rotor.

34. The braking system of claim 23 wherein the moving friction surface is axially aligned with the body of the rotor.

35. The braking system of claim 34 wherein the moving friction surface is located radially outboard of the body of the rotor.

36. The braking system of claim 34 wherein the moving friction surface is located radially inboard of the body of the rotor.

37. The braking system of claim 23 wherein the moving friction surface comprises a circular friction surface that circumscribes a rotational axis of the wheel.

38. The braking system of claim 23 wherein the stator is radially spaced from the rotor with a radially extending air gap therebetween.

39. The braking system of claim 23 wherein the stator is axially spaced from the rotor with an axially extending air gap therebetween.

40. The braking system of claim 23 wherein the friction brake unit includes an antilock brake mechanism, and wherein the switched reluctance generator provides wheel speed data to a controller for use in controlling operation of the antilock brake mechanism.

41. The braking system of claim 40 wherein the friction brake unit comprises a hydraulic-mechanical disc brake.

42. The braking system of claim 40 wherein the friction brake unit comprises an electro-mechanical disc brake and an electric motor for driving the disc brake.
